(19) United States
(12) Patent Application Publication
(10) Pub. No.: US 2015/0174683 A1
(43) Pub. Date: Jun. 25, 2015

(54) PURGE CAN FOR PURGING PIPE

(71) Applicant: John Daniel Archibald, JR., Walker, LA (US)

(72) Inventor: John Daniel Archibald, JR., Walker, LA (US)

(21) Appl. No.: 14/137,144

(22) Filed: Dec. 20, 2013

(51) Int. Cl. B23K 9/32; B23K 31/02; B23K 37/00

(52) U.S. Cl. CPC B23K 9/326; B23K 37/00; B23K 31/02

(57) ABSTRACT

A purge can assembly may include a tube that has a first end and a second end. The tube may include a plurality of slots. Enclosed within the tube may be a piece of steel wool. Wrapped within the piece of steel wool may be a mesh screen. A gas connector may attach to the first end of the tube. A cap may attach to the second end of the tube.

### BACKGROUND OF THE INVENTION

The present invention relates to purging pipes and, more particularly, to a purge can for purging pipes.

Currently, when purging long or large alloy pipes, it sometimes takes several hours and a large amount of gas. The purge dam or plug is installed in the weld end of the pipe and only covers a small area for purging even though the purge dam itself may be three to four feet long. The purge dam may also be required to sit against both sides of a weld. The purge dam can easily be plugged and therefore stop working during the process.

As can be seen, there is a need for a purge can that allows for dispersing wider, a quicker purge and can be used in multiple locations along a pipe.

### SUMMARY OF THE INVENTION

In one aspect of the present invention, a purge can assembly comprising: a tube having a first end and a second end, wherein the tube comprises a plurality of slots along the tube; a piece of steel wool enclosed by the tube; a mesh screen enclosed by the piece of steel wool; a gas connector attached to the first end of the tube; and a cap attached to the second end of the tube.

In another aspect of the present invention, a method of purging a pipe comprising: placing into a pipe a purge can assembly comprising: a tube having a first end and a second end, wherein the tube comprises a plurality of slots along the tube; a piece of steel wool enclosed by the tube; a mesh screen enclosed by the piece of steel wool; a gas connector having a female connection, attached to the first end of the tube; and a cap attached to the second end of the tube; connecting a purge gas hose to the gas connector of the purge can assembly; and adjusting the pressure of the gas as required.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a rear perspective view of an exemplary embodiment of the present invention;

FIG. 3 is an exploded view of an exemplary embodiment of the present invention;

FIG. 4 is a section view of an exemplary embodiment of the present invention, taken along line 4-4 in FIG. 1; and

FIG. 5 is a section view of an exemplary embodiment of the present invention, taken along line 5-5 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a purge can assembly that may include a tube that has a first end and a second end. The tube may include a plurality of slots. Enclosed within the tube may be a piece of steel wool. Wrapped within the piece of steel wool may be a mesh screen. A gas connector may attach to the first end of the tube. A cap may attach to the second end of the tube. A method of purging a pipe using the purge can assembly may provide flexibility as to where the purging may be conducted.

The present invention may allow for the break up and softening of hard flows of a gas, making the gas spread throughout the pipe or other orifice quicker and more efficiently than what is currently available. The purge can assembly may direct the gas in a wide arc that may allow purge coverage of a larger area of the pipe, requiring less time to complete a task. The purge can assembly may be placed anywhere along a pipe in order to purge the pipe.

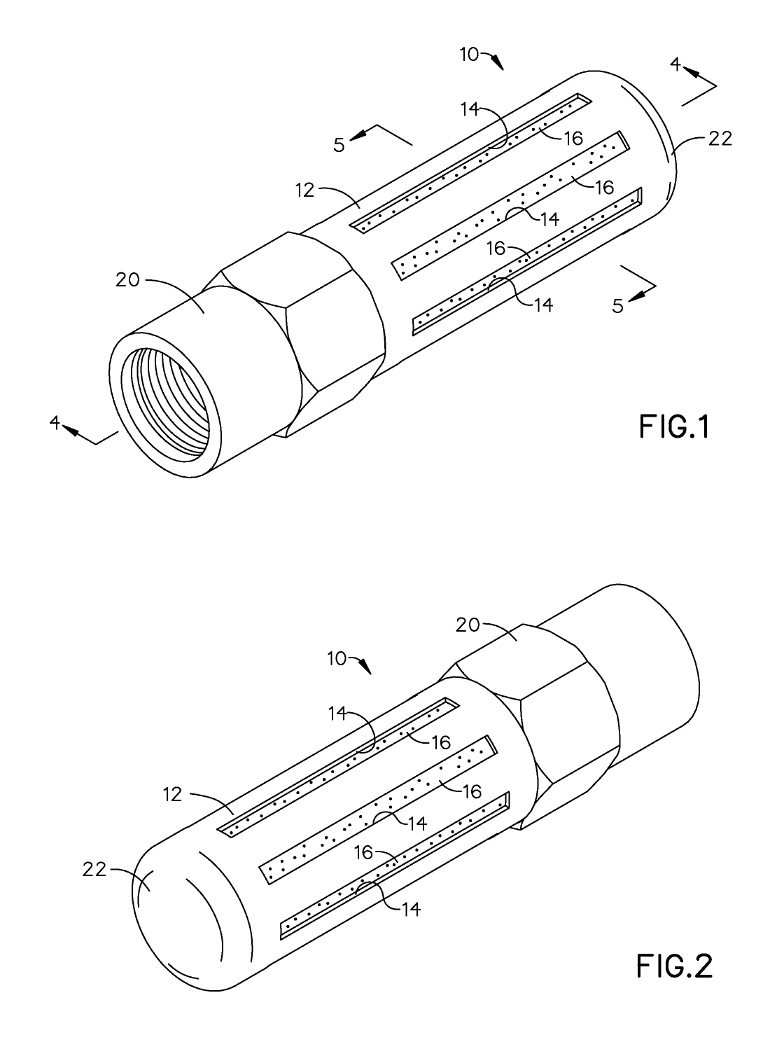

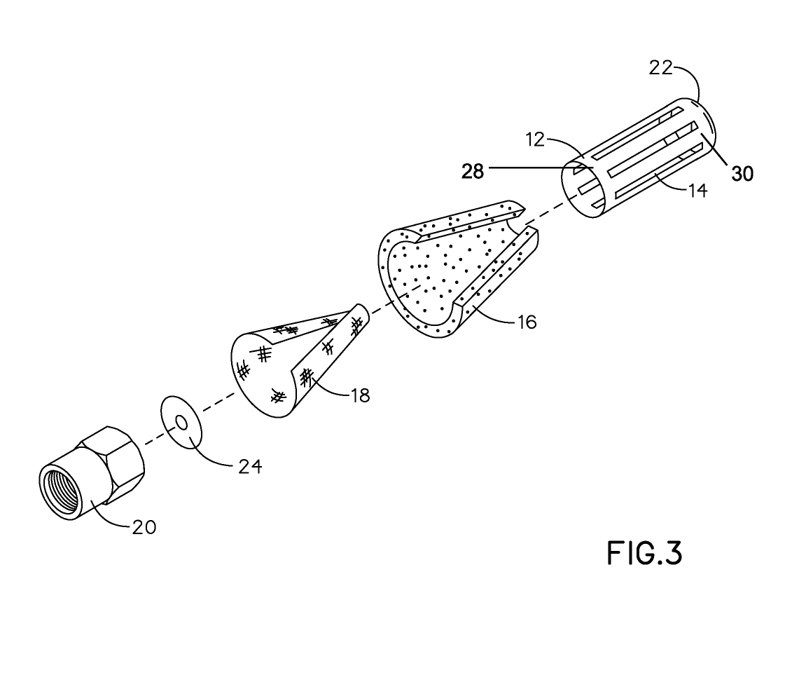

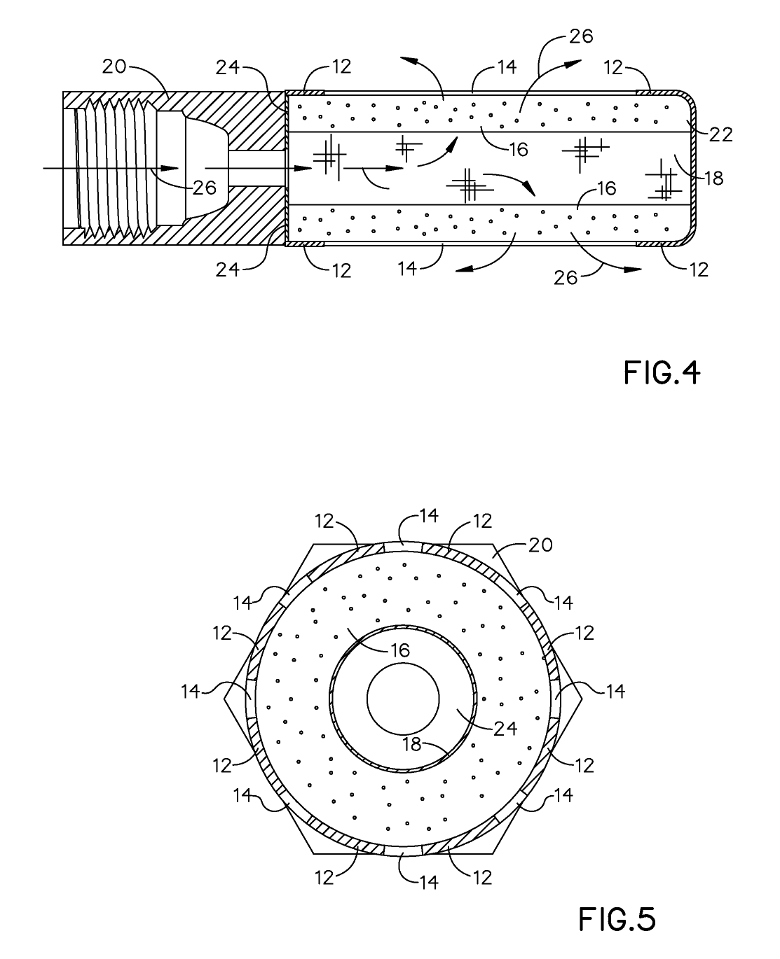

As is illustrated in FIGS. 1 through 5, the purge can assembly 10 may include a tube 12. The tube 12 may have a first end 28 and a second end 30. A plurality of slots 14 may be located along the tube 12. Enclosed inside the tube 12 may be a piece of steel wool 16. Enclosed within the piece of steel wool 16 may be a mesh screen 18. A gas connector 20 may be attached to the first end 28 of the tube 12. A cap 22 may be attached to the second end 30 of the tube 12.

In certain embodiments, a connector plate 24 may be attached to the first end 28 of the tube 12. The gas connector 20 may be attached to the first end 28 of the tube 12 over the connector plate 24 in these embodiments. In certain embodiments, the steel wool 16 may be of an extra fine grade. In certain embodiments, the tube 12 may be approximately one inch in width and approximately 2.5 inches in length. In certain embodiments, the tube 12 may be approximately ¾ inch in width. The width and length of the tube 12 may vary depending on the pipe, duct or the like, that needs to be purged. In certain embodiments, the plurality of slots 14 may be evenly spaced around the tube 12.

A method of making the purge can assembly 10 may include the following. In certain embodiments, the tube 12 may be used. The tube 12 may be cut so that the plurality of slots 14 are approximately ⅛ inch in width and approximately 2 inches in length. A cap 22 may be placed on the second end 30 of the tube 12. The mesh screen 18 may be sized so that the openings are approximately 1/64 inches in size. The mesh screen 18 may be rolled up. The steel wool 16 may wrap around the mesh screen 18 and both the mesh screen 18 and the steel wool 16 may be inserted into the tube 12. The steel wool 16 may be of an extra fine grade. The gas connector 20 may have an approximately ⅝ inch female connection and be placed on the first end 28 of the tube 12 at this point. In certain embodiments, the purge can assembly 10 may include a connector plate 24 sandwiched in between the gas connector 20 and the first end 28 of the tube 12.

A method of using the purge can assembly 10 may include the following. The purge can assembly 10 may be used when a pipe, duct or the like needs to be purged. In certain embodiments, the purge can assembly 10 may be used when a space restriction may not allow the use of a commonly used purge dam. The purge can assembly 10 may also be used in conjunction with the commonly used purge dam. The mesh screen 18 and the steel wool 16 allow for the breakup of the gas 26 through the pipe so that the purge may be completed at a quicker pace. The steel wool 16 and the mesh screen 18 allow for a more even distribution of the gas 26 that may reduce purge time and gas 26 uses. The purge can assembly 10 may be used in places such as where a flange or hole may be installed along a pipeline, downstream of the weld. In certain embodiments, the purge can assembly 10 may be placed upstream of the weld. In certain embodiments, the purge can assembly 10 may be placed around the weld point. When used with the flange, the purge can assembly 10 may be placed in the spacing of the flange. The purge can assembly 10 may work around the weld locations or further along the inside of a pipe. A gas hose may be connected to the gas connector 20 of the purge can assembly 10, thereby providing gas 26 to the inside of the pipe. In certain embodiments, the gas 26 used may be an inert gas 26 such as nitrogen, argon or the like. The pipe purged may be an alloy pipe.

It should be understood, of course, that the foregoing relates to exemplary embodiments of the invention and that modifications may be made without departing from the spirit and scope of the invention as set forth in the following claims.

What is claimed is:

1. A purge can assembly comprising:
a tube having a first end and a second end, wherein the tube comprises a plurality of slots along the tube;
a piece of steel wool enclosed by the tube;
a mesh screen enclosed by the piece of steel wool;
a gas connector attached to the first end of the tube; and
a cap attached to the second end of the tube.

2. The purge can assembly of claim 1, wherein the gas connector has a female connection.

3. The purge can assembly of claim 1, wherein the plurality of slots are along the length of the tube.

4. The purge can assembly of claim 3, wherein the plurality of slots are cut approximately ⅛ inch in width and approximately two inches in length, wherein the plurality of slots are spaced evenly around the tube.

5. The purge can assembly of claim 1, wherein the tube is approximately one inch in diameter and approximately 2.5 inches in length.

6. The purge can assembly of claim 1, wherein the piece of steel wool is extra fine grade.

7. The purge can assembly of claim 1, wherein the mesh screen has openings that are approximately 1/64 inches in size.

8. The purge can assembly of claim 1, further comprising a connector plate attached to the first end of the tube and sandwiched between the tube and the gas connector.

9. A method of purging a pipe comprising:
placing into a pipe a purge can assembly comprising: a tube having a first end and a second end, wherein the tube comprises a plurality of slots along the tube; a piece of steel wool enclosed by the tube; a mesh screen enclosed by the piece of steel wool; a gas connector having a female connection, attached to the first end of the tube; and a cap attached the second end of the tube;
connecting a purge gas hose to the gas connector of the purge can assembly; and
adjusting the pressure of the gas as required.

10. The method of claim 9, further comprising the step of placing the purge can assembly into the spacing of a flange along the pipe.
